(19) United States
(12) Patent Application Publication
(10) Pub. No.: US 2007/0243505 A1
(43) Pub. Date: Oct. 18, 2007

(54) System and method for the testing of air vehicles

(75) Inventors: Manaswini Rath, Bangalore (IN); Pragnya Desai, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/403,471

(22) Filed: Apr. 13, 2006

(51) Int. Cl. G09B 9/02; G09B 9/08

(52) U.S. Cl. 434/29; 434/30

(57) ABSTRACT

In an embodiment, an aviation system on an air vehicle includes an avionics platform having a control module. The system also includes a control unit having a transceiver, an input device, a processing unit, and a communication device. The system further includes a communication subsystem that couples the control unit and the avionics platform. The communication device enables communication between the processing unit and a plurality of sensors and actuators of the air vehicle to facilitate simulation of a flight test of the air vehicle. The simulation is performed as a function of relative displacements of at least one servo actuated by the actuators in response to an input signal from at least one of the control unit and the control module.

### TECHNICAL FIELD

Various embodiments relate to the testing of air vehicles, and in an embodiment, but not by way of limitation, to the testing of unmanned air vehicles (UAV) using servos and actuators on the unmanned air vehicle.

### BACKGROUND

Simulations are used to test and verify the operations of many products and systems. One class of products in which simulations are heavily used are the simulated testing of air vehicles, and in particular, unmanned air vehicles. However, even the best simulation system falls short of an actual test of an actual air vehicle or unmanned air vehicle.

### SUMMARY

In an embodiment, an aviation system on an air vehicle includes an avionics platform having a control module. The system also includes a control unit having a transceiver, an input device, a processing unit, and a communication device. The system further includes a communication subsystem that couples the control unit and the avionics platform. The communication device enables communication between the processing unit and a plurality of sensors and actuators of the air vehicle to facilitate simulation of a flight test of the air vehicle. The simulation is performed as a function of relative displacements of at least one servo actuated by the actuators in response to an input signal from at least one of the control unit and the control module.

### BRIEF DESCRIPTION OF THE DRAWINGS

FIG. 1 is a block diagram illustrating on board modules, ground station modules, and a link between them.

FIG. 2 illustrates an embodiment of a test set up configuration of a hardware in loop simulation.

FIG. 3 illustrates an example embodiment of an IO card.

FIG. 4 illustrates a pilot control display of a ground control station.

FIG. 5 illustrates an example embodiment of a flow diagram of a control command decoding at an on board control unit in response to ground control station control commands.

FIG. 6 illustrates an example embodiment of a flow diagram of a pilot control system.

FIG. 7 illustrates an example embodiment of a process to test an unmanned or other air vehicle.

FIG. 8 illustrates an embodiment of a computer system upon which embodiments of the invention may be practiced.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for an architecture for an unmanned air vehicle system, in accordance with embodiments of the invention. A number of figures show flow diagrams illustrating operations for an architecture for an unmanned air vehicle system. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In an embodiment, a Hardware-in-the-Loop Simulation (HILS) methodology provides for efficient working of actuator controls on an unmanned air vehicle (UAV) or other air vehicle from the ground, which in an embodiment provides a testing environment for such UAVs or other air vehicles. In various embodiments, the HILS may alternate between a manual mode, an autonomous mode, and a shared mode. In an embodiment, actual on board hardware performs switching and pulsed width modulations (PWM). Logic and algorithms may be executed in a development environment, and the output therefrom is ported to the on board hardware system and verified for the functionalities as well as the timing.

In the manual mode, a UAV can be controlled by a pilot on the ground using either radio control (RC) or a joystick integrated in a ground control system (GCS). The GCS may also be referred to as a control unit. In the autonomous mode, control is provided by an on board avionics system. In the shared mode of operation, manual control is still allowed even when the UAV is in the autonomous mode. In all modes of operation, UAV control is based on actuator movements that are directed by Pulse Width Modulation (PWM) signals fed to corresponding servos of the actuators. In one or more embodiments of the HILS, parts of a pure simulation are replaced with actual physical components. In such embodiments, PWM pulses are simulated in the development environment, and generated by a processor on the on board avionics system to activate the connected servos.

In an embodiment of an HILS system, the HILS uses actual aircraft servos that are connected to actual actuators. With such a setup, movement of the servos in the HILS assures an associated movement of actuators in the UAV. PWM pulses are generated based on angle input either from the avionics system or from the GCS. A Radio Frequency (RF) unit is used in the case of GCS control to interface between the on board system and the GCS. In embodiments in which a PWM signal is generated by on board avionics, the system is emulated through a development environment. In one embodiment, the development environment is an MPLAB emulator circuit connected to a data acquisition board (also known as an IO board or an IO module) on the on board avionics system. To verify the control from the RC or from the GCS, a loop is created between the development environment system and another system where GCS runs.

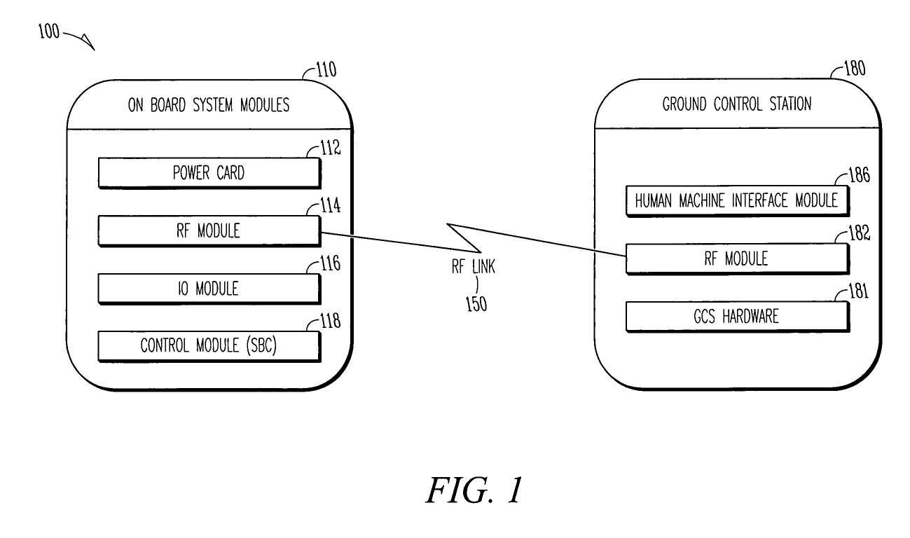

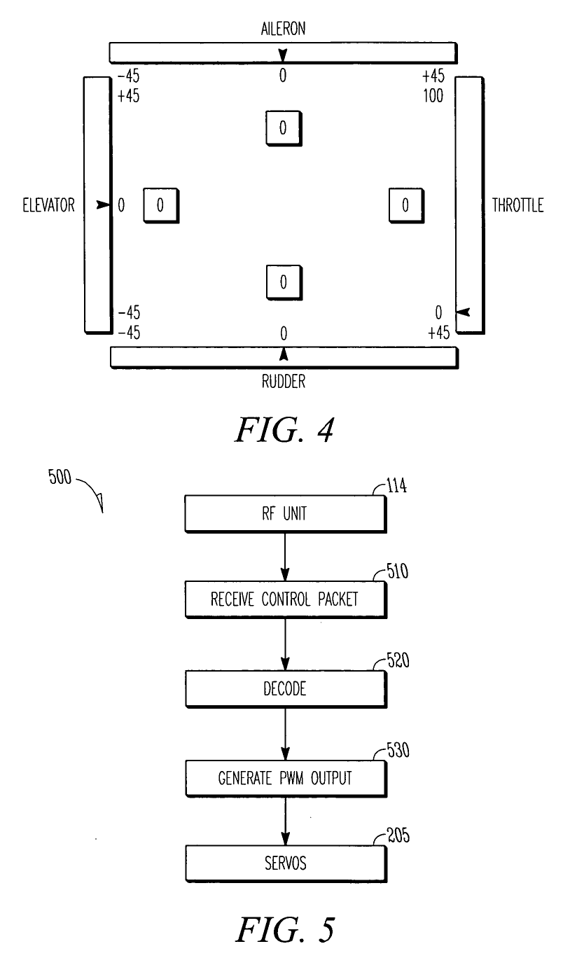

An embodiment of an HILS system 100 including the on board modules 110 of an air vehicle, a ground control station (GCS) 180, and a link 150 between the two, is illustrated in FIG. 1. The on board modules or avionics system 110 includes a power card 112, an RF module 114, an IO module 116, and a control module (single board computer (SBC)) 118. The GCS 180 includes a GUI module 186 (human machine interface module), a GCS hardware unit 181, and an RF module 182. A portion of the graphical user interface that illustrates controls for an aileron, throttle, rudder, and elevator subsystem displays is illustrated in FIG. 4. The GCS 180 is responsible for loading the necessary information for the onboard system 110 and monitoring the progress of a UAV through the mission profile. The GCS 180 is a combination of various subsystems which control and coordinate the activities of an airborne UAV. The GCS 180 can be viewed as hardware and software bounded together for controlling the UAV. In an embodiment, the communication system 150 is an RF based system.

Referring back to FIG. 4, the rudder, elevator, aileron, and throttle control (REAT) is a GUI based control module integrated with the GCS 180 to control the actuators remotely from the GCS. In the GCS, the controls are operated by both a joystick and a keyboard. The display of FIG. 4 indicates the movement of either the joystick or the keyboard.

The RF system 150 encodes, modulates, and translates a base band signal into a RF signal. Both the on board avionics system 110 and the GCS 180 have RF boards (114 and 182 respectively in FIG. 1). In one embodiment, the boards operate at a frequency of 2.4 GHz. In a particular embodiment, the RF board is a commercial off the shelf (COTS) 2.4 GHz board.

The GCS 180 is divided into two subsystems—a GCS hardware subsystem and a GCS software subsystem. The GCS hardware subsystem is the electronic system and the platform on which the GCS runs. The GCS includes a CPU card for backend processing, a monitor 186 to serve as the GUI, and an RF system 182. The GCS software subsystem includes the software modules that run on the GCS hardware.

The GCS 180 is responsible for several functionalities. First, it establishes connection to the UAV. Second, it displays the status of the UAV on the display 186, based on data received from telemetry. The GCS 180 further controls the UAV in the manual mode of flight through input devices such as a joystick 189, keyboard 184, and a mouse. The GCS 180 also provides control support during share mode operation of the UAV through the control devices.

In an embodiment, the GCS display 186 (or GUI) is similar to a typical cockpit display. Such a display may include a primary flight display, a navigational display, sensors health indication display, aircraft information display, real time graph for sensor data, and real time video display. The display 186 may also integrate the communication subsystem to the flight simulator and methods to verify a communication link between the ground system 180 and the UAV. Further, the GCS display 186 may provide functions to validate the ground and on board communications system, including range and tracking performance analysis. That is, the GCS display panel 186 provides the necessary panels required for the remote piloting of the UAV. A ground pilot is provided with the current information of an airborne UAV. This information permits the ground pilot to know the status of the UAV which assists the ground pilot in monitoring the activities of the UAV.

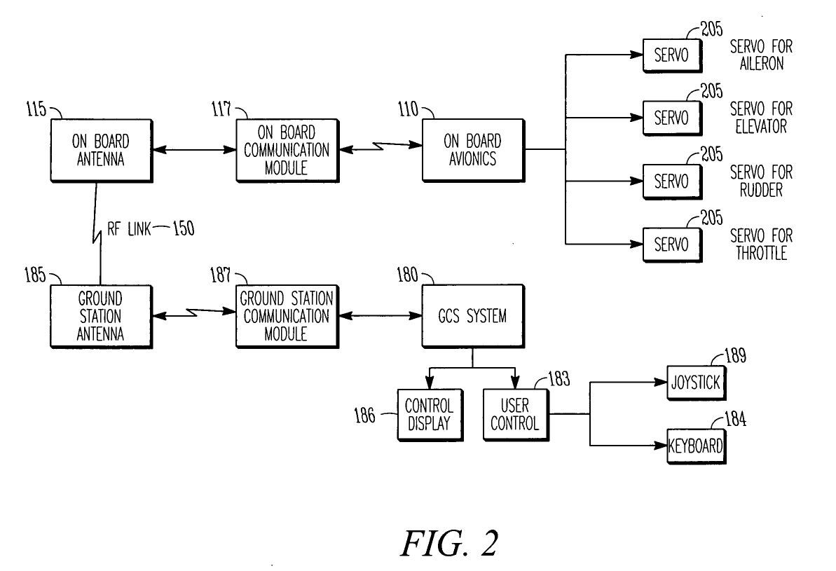

FIG. 2 illustrates an example embodiment of a test set up configuration used to implement an embodiment of the HILS. The GCS system 180 includes a control display 186 and a user control module 183. A joystick 189 and/or a keyboard 184 may be coupled to the user control module 183. The GCS 180 communicates with the on board avionics 110 via a GCS communication module 187, a GCS antenna 185, an RF link 150, and the onboard antenna 115 and the on board communication module 117 of the on board avionics system 110. The on board avionics 110 is coupled to a plurality of servos 205 for an aileron, an elevator, a rudder, and a throttle.

The test set up was developed with two major systems. The avionics algorithms that need to be tested are ported to a development environment. The development environment is considered the on board avionics system. The four servo motors 205 are connected to the development board. The angular movements of these servo motors are characterized as the servo control characteristics. An RF unit is connected to the development environment for communication purposes. The other major system of the test set up is the ground control station (GCS) 180. The GCS 180 includes a lap top or other processing device and an RF unit. The RF unit is connected to the processing unit through a serial port. One or more input devices, for example the keyboard 184 and the joystick 189, are connected to the processing device. Based on the input from the input devices, the GCS 180 generates a control command and sends the control command to the development environment using the RF link 150.

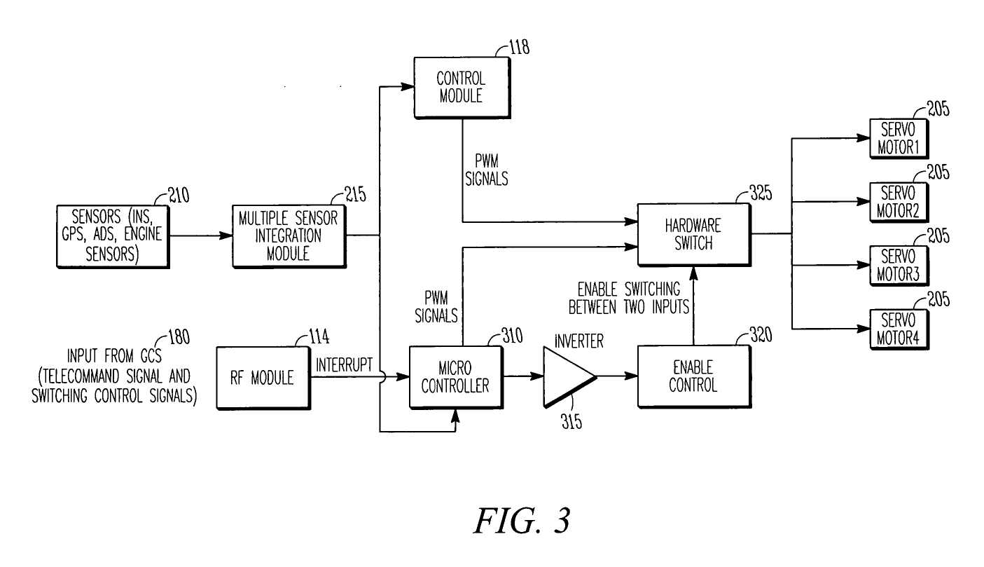

FIG. 3 illustrates a block diagram of the IO card. Input from the GCS 180 is received by the RF module 114 and supplied to a microcontroller 310. Sensor input 210 is input into a sensor integration module 215, and the output of the sensor integration module 215 is supplied to the microcontroller 310 and the control module 118. The microcontroller 310 and the control module 118 generate PWM signals, and these signals are input into a hardware switch 325. Output form the microcontroller 310 is also input into an inverter 315, and an enable controller 320, which is used to switch between the two inputs into the hardware switch 325. The hardware switch 325 is then coupled to a plurality of servo motors 205.

The IO card executes the functionalities of switching, multiple sensor integration, and telemetry/telecommands. The switching functionality changes the operation mode control from autonomous mode to manual mode and vice versa. In an embodiment, the system validates the functionality of switching between the different modes of operation (autonomous mode and manual mode) using the simulation models in the control unit 180. The switching is achieved through the use of electronic switches, and the enable control is controlled by the microcontroller. The switching is achieved through the use of microcontroller, electronic switches through enable control 320. The multiple sensor integration 215 provides the ability to integrate a number of sensors to the system. Inputs from all of these sensors are required to generate the actuator control signals in the autonomous mode of operation. The telemetry/telecommand functionality enables the downloading of on board information to the GCS 180 and also the uploading of control commands from the GCS 180 to the on board system 110.

As disclosed supra, the HILS may function in a manual mode, an autonomous mode, or a shared mode. In the manual mode, controls and control surfaces (aileron, elevator, rudder, throttle) of a UAV are controlled manually from the GCS 180 through the on board RF unit 114. The signals received by the RF module 114 are analyzed and interpreted by the DSP 315 in the IO module 116, and a corresponding PWM signal is generated for controlling the actuators 205.

In the shared mode of operation, the GCS 180 is given an option to control UAV control surfaces either through the autonomous mode or through the manual mode. In the shared mode, the control module 118 takes the control by default. However, whenever required, the UAV can also be controlled from GCS 180 commands. In the shared mode, the on board system 110 responds to telecommand signals from the GCS 180 and provides the same to the IO card 116 to generate control signals.

In a HILS set up such as that illustrated in FIG. 1, a test may be performed in three stages. A first stage generates PWM pulses from the RC module 114. A second stage generates PWM pulses from the GCS 180. A third stage generates PWM pulses from the control module 118.

In the stage in which PWM pulses are generated from the RC module 114, one of the input ports of a line driver is activated, and the corresponding four outputs are connected to the four servos 205. The servos represent the four control surfaces—i.e., aileron, elevator, rudder and throttle. The functionality (caused by the PWM pulses) is observed through the movement of servo heads with the movement of controls on an RC transmitter.

In the stage in which PWM pulses are generated from the GCS 180, the controls are operated by both the joystick 189 or the keyboard 184. The joystick is integrated to the PC that acts as the GCS computer system. With input from the joystick 189 or the keyboard 184, corresponding angular values are generated by the GCS computer. These angular values are sent to the on board system via the RF system. These signals are received by the RF system 114 of the on board avionics system and processed by the IO module 116. These signals are routed directly to the servos 205 through a line driver default port.

In the stage in which the PWM pulses are generated from the control module 118 (autonomous mode), PWM signals to activate the servos 205 are generated by the IO module 116. The generation of the PWM signal is based on the angular inputs from the flight control system (FCS) and the flight management system (FMS) that run on the control module 118 platform. The IO module is interfaced to the control module 118 through an RS232 serial port. This mode of operation may be invoked by sending an interrupt signal from the GCS 180 computer. The generated PWM pulses vary as per the angular inputs supplied by the FCS in the control module 118.

FIG. 7 illustrates a general process 700 of an embodiment that may be used in connection with the embodiment of FIG. 1 and other embodiments. Referring to FIG. 7, a virtual flight environment is simulated with flight simulation software at operation 710. In this embodiment, the flight simulation software is adapted to generate simulated models for on board sensors and on board actuators. At operation 720 a framework comprising on board algorithms is linked to the flight simulation software. The framework is configurable to receive inputs from the on board sensors and to generate flight control commands in response to the on board sensor input. The flight control commands are interfaced to one or more of simulated actuator models and actual actuators in communication with the framework at operation 730.

Software modules that support the HILS system are resident on both the on board environment 110 and the GCS environment 180. In the on board environment 110, the software modules pertain to PWM generation, interrupts, and switching. In the GCS simulation environment 180, the software modules pertain to the GUI, integrating the GCS 180 to the RF system 182 through the RS232, the GCS interface to the joystick, and telecommand encoding and framing. FIG. 5 illustrates an example embodiment of a flow diagram 500 of the functionality of control command decoding at the on board unit in response to the GCS control commands. When the on board RF system 114 receives the control commands at operation 510, it transfers these commands to the IO module of the simulation environment. The control signals are then decoded at the IO module at operation 520, and corresponding PWM signals are generated at operation 530 and fed to the respective servos 205.

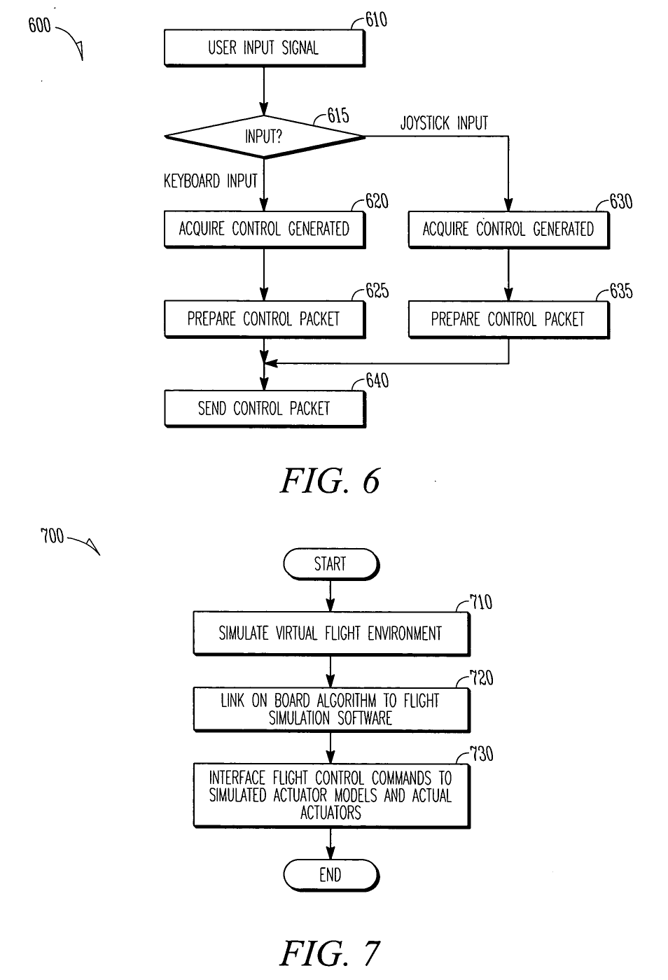

FIG. 6 illustrates an example embodiment of a flow diagram 600 of a ground pilot's control system. On the on board side, after receiving the control packet from the ground system at 610, the mode of input is determined at 615, the on board control software decodes the control packet and generates the required PWM wave (620, 625, 630, 635). In an embodiment, the control packet includes an identifier and an input angle in degrees. For example, in an embodiment, a control packet might contain the following: “*45,@−45,#100,$45”. The “*” identifies the servo used to control the aileron. The “$” identifies the servo used to control the elevator. The “#” identifies the servo used to control the throttle. The “@” identifies the servo used to control the rudder.

As illustrated in FIGS. 5 and 6, in the HILS on board servos 205, movement is controlled by the input generated in the ground control station 180. Specifically, the input generated by the ground pilot is captured by the ground control software either through the keyboard 184 or the joystick 189. When a ground pilot generates a control signal, the ground control software captures the action signal generated by the ground pilot. The first step is to generate the type of input (keyboard or joystick) that was used to generate the control signal. Once the control information is gathered, the ground software packages this information into a telecommand packet and transmits it to the RF system 182. The RF system 182 then transmits this control information through the communications system 150 to the on board RF system 114.

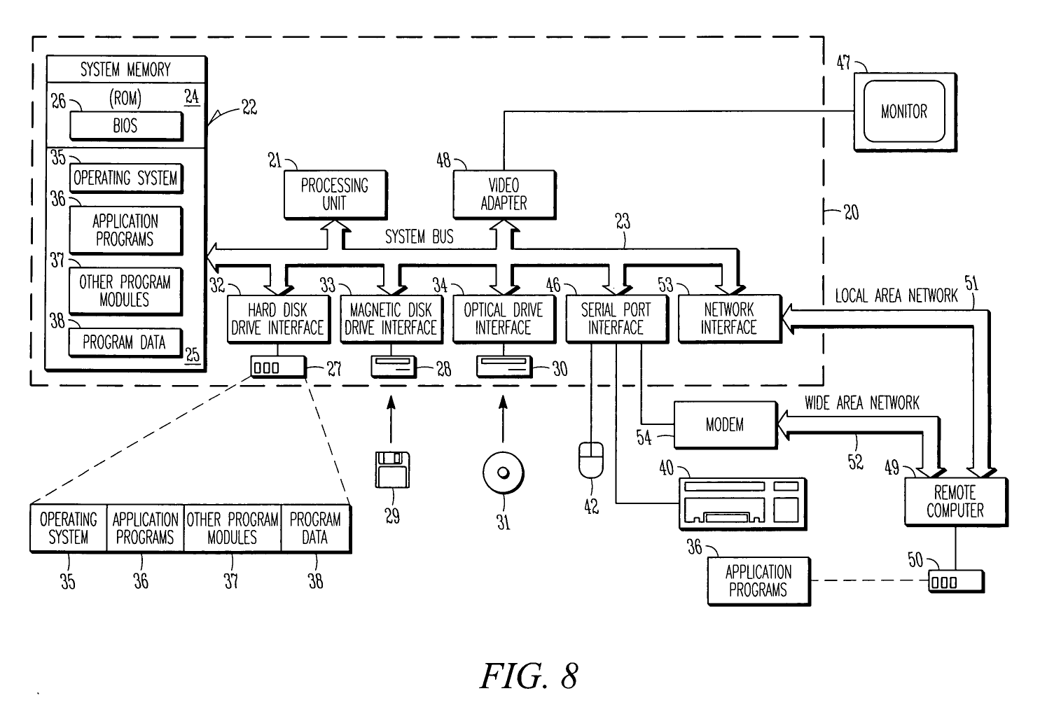

FIG. 8 is an overview diagram of a hardware and operating environment in conjunction with which embodiments of the invention may be practiced. The description of FIG. 8 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 8, a hardware and operating environment is provided that is applicable to any of the servers and/or remote clients shown in the other Figures.

As shown in FIG. 8, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 8 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A system comprising:
an avionics platform having a control module, said avionics platform residing on an air vehicle;
a control unit comprising a transceiver, an input device, a processing unit, and a communication device; and
a communication subsystem to couple said control unit and said avionics platform;
wherein said communication device enables communication between said processing unit and a plurality of sensors and actuators of said air vehicle to facilitate simulation of a flight test of said air vehicle; and further
wherein said simulation is performed as a function of relative displacements of at least one servo actuated by said actuators in response to an input signal from at least one of said control unit and said control module.

2. The system of claim 1, wherein said avionics platform further comprises an I/O module to communicate with said control module and said control unit, and further wherein said IO module is configurable to actuate one or more of said servos as a function of input from one or more of said control unit and said control module.

3. The system of claim 1, wherein said servos are further configured to control an aileron, an elevator, a throttle, and a rudder.

4. The system of claim 1, wherein said avionics system further comprises:
one or more of a RC receiver and a RF circuit coupled to said IO module; and
a circuit to select as input to said servos input from said control module, said RC receiver, or said RF circuit.

5. The system of claim 1, wherein said air vehicle is an unmanned air vehicle.

6. The system of claim 1, wherein a rotation of said servos is a function of angular displacements and responsive to a pulse width modulation signal.

7. The system of claim 1, wherein a mode of operation of said air vehicle comprises a manual mode, an autonomous mode, and a shared mode.

8. The system of claim 6, wherein said angular displacements and data to generate said pulse width modulation signal originate from one or more of said control unit and said control module.

9. The system of claim 7, wherein said system validates a functionality of switching between different modes of operation including switching between said autonomous mode and said manual mode using simulation models in said control unit.

10. The system of claim 7, wherein in said autonomous mode said air vehicle is controlled by a flight management system and a flight control system.

11. A method comprising:
simulating a virtual flight environment with flight simulation software, said flight simulation software adapted to generate simulated models for on board sensors and on board actuators;
linking a framework comprising on board algorithms to said flight simulation software, said framework configurable to receive inputs from said on board sensors and to generate flight control commands in response to input from said on board sensors; and
interfacing said flight control commands to one or more of simulated actuator models and actual actuators in communication with said framework.

12. The method of claim 11, wherein said on board actuators include an aileron, an elevator, a throttle, and a rudder.

13. The method of claim 11, wherein said virtual flight environment operates in a manual mode by receiving input from a ground control station.

14. The method of claim 11, wherein said virtual flight environment operates in a shared mode, wherein in said shared mode said virtual flight environment receives input from one or more of said flight simulation software and a ground control station.

15. The method of claim 11, wherein said actuators operate as a function of angular displacements and pulse width modulation signals.

16. The method of claim 15, wherein said angular displacements originate from one or more of a ground control station or said flight simulation software.

17. A machine readable medium comprising instructions for executing a method comprising:
simulating a virtual flight environment with flight simulation software, said flight simulation software adapted to generate simulated models for on board sensors and on board actuators;
linking a framework comprising on board algorithms to said flight simulation software, said framework configurable to receive inputs from said on board sensors and to generate flight control commands in response to said on board sensor input; and
interfacing said flight control commands to one or more of simulated actuator models and actual actuators in communication with said framework.

18. The machine readable medium of claim 17, wherein said on board actuators include an aileron, an elevator, a throttle, and a rudder.

19. The machine readable medium of claim 17, wherein said actuators operate as a function of angular displacements and pulse width modulation signals.

20. The machine readable medium of claim 19, wherein said angular displacements originate from one or more of a ground control station or said flight simulation software.
